(19) United States
(12) Patent Application Publication
(10) Pub. No.: US 2025/0181672 A1
(43) Pub. Date: Jun. 5, 2025

(54) TRIAL PRODUCTION CONDITION PROPOSAL SYSTEM AND TRIAL PRODUCTION CONDITION PROPOSAL METHOD

(71) Applicant: NGK INSULATORS, LTD., Nagoya-City (JP)

(72) Inventors: Natsuki ITO, Nagoya-Shi (JP); Shingo SOKAWA, Okazaki-Shi (JP); Yuki OKA HASHIMOTO, Kariya-Shi (JP)

(73) Assignee: NGK INSULATORS, LTD., Nagoya-City (JP)

(21) Appl. No.: 19/051,384

(22) Filed: Feb. 12, 2025

Related U.S. Application Data
(63) Continuation of application No. PCT/JP2023/027145, filed on Jul. 25, 2023.

(30) Foreign Application Priority Data
Sep. 29, 2022 (JP) 2022-157142

(51) Int. Cl. G06F 17/18

(52) U.S. Cl. CPC G06F 17/18

(57) ABSTRACT

A trial production condition proposal system 1 is a system for proposing a trial production condition(s) for a material to a material developer and includes a regression model construction processing unit 112 and a trial production condition proposal processing unit 113. The regression model construction processing unit 112 executes regression model construction processing on measured characteristics data indicating an actual measurement result of characteristics of the material. The trial production condition proposal processing unit 113 searches for an optimum trial production condition for the material by using the constructed regression model and executes trial production condition proposal processing based on a search result. The regression model construction processing includes: processing for calculating a weight reference which is a reference for weighting on the measured characteristics data; and processing for performing weighting on the measured characteristics data based on the calculated weight reference.

### CROSS-REFERENCE TO RELATED APPLICATION

This application is a continuation application of PCT/JP2023/027145 filed on Jul. 25, 2023, which claims the benefit of priority of Japanese Patent Application No. 2022-157142 filed on Sep. 29, 2022, the entire contents of which are incorporated herein by reference.

### TECHNICAL FIELD

The present invention relates to a system and method for proposing trial production conditions for a material(s) to a material developer(s).

### BACKGROUND ART

In the field of material science to do research and development of materials, a method called “Materials Informatics (MI)” for efficiently predicting physical properties, structures, etc. of materials by using information technology (Informatics) such as statistical analysis and machine learning is widely used nowadays. Regarding the research and development of the materials by using this material informatics, for example, a technology of WO 2021/044913 is known. WO 2021/044913 discloses a system for estimating preparation conditions for substances having optimum physical properties and structures from a dataset including preparation conditions for each of a plurality of substances, which are samples, and substance information indicating physical properties and structures of the respective substances.

### SUMMARY OF THE INVENTION

### Problems to be Solved by the Invention

At a site(s) of the material development using the material informatics, various kinds of evaluation tests are usually conducted to actually measure characteristics of a material(s), which is an object to be developed, and data indicating actual measurement results (hereinafter referred to as “measured characteristics data”) are obtained. Then, various kinds of learned machine learning models are constructed by inputting and learning the acquired measured characteristics data into a computer and a condition(s) for trial production of the material (hereinafter referred to as the “trial production condition(s) ”) is estimated by using the constructed learned machine learning models. Under this circumstance, accuracy of the computer to estimate the trial production condition(s) (hereinafter referred to as “estimate accuracy”) is determined by the accuracy of the learned machine learning models used for the processing for estimating the trial production condition(s). Then, the accuracy of the learned machine learning models are generally decided according to, for example, the number of pieces of the learned measured characteristics data when constructing the machine learning models (hereinafter also referred to as the “number of samples”) or a degree of variations in their distribution.

Under this circumstance, the measured characteristics data which are input to the computer in order to construct the machine learning model(s) (hereinafter also referred to as “learning data”) are generally characterized in that the number of explanatory variables are extremely large, while the number of samples is often small. Then, if the number of pieces of the learning data is small or if there is a bias in distribution of the learning data, the computer cannot construct a highly-accurate machine learning model(s). Therefore, in such a case, there is fear that sufficient estimate accuracy may not be obtained even if the computer is caused to execute the processing for estimating the trial production condition(s) by using the constructed machine learning model(s).

In light of the above-described problem, it is an object of the present invention to provide a technology capable of accurately proposing an optimum trial production condition for the material even when the number of pieces of the learning data used to construct a machine learning model(s) is small or when there is a bias in distribution of the learning data.

### MEANS TO SOLVE THE PROBLEMS

A trial production condition proposal system according to the present invention proposes a trial production condition for a material to a material developer and includes a regression model construction processing unit and a trial production condition proposal processing unit. The regression model construction processing unit executes regression model construction processing on measured characteristics data indicating an actual measurement result of characteristics of the material. The trial production condition proposal processing unit searches for an optimum trial production condition for the material by using the constructed regression model and executes trial production condition proposal processing based on a search result. The regression model construction processing includes: processing for calculating a weight reference which is a reference for weighting on the measured characteristics data; and processing for performing weighting on the measured characteristics data based on the calculated weight reference.

Moreover, a trial production condition proposal method according to the present invention is a method for proposing a trial production condition for a material to a material developer by using a computer. This trial production condition proposal method causes the computer to execute regression model construction processing and trial production condition proposal processing. The regression model construction processing represents processing for constructing a regression model regarding measured characteristics data indicating an actual measurement result of characteristics of the material. The trial production condition proposal processing represents processing for searching for an optimum trial production condition for the material by using the constructed regression model, and proposing the trial production condition for the material based on a search result. The regression model construction processing includes: processing for calculating a weight reference which is a reference for weighting on the measured characteristics data; and processing for performing weighting on the measured characteristics data based on the calculated weight reference.

Other than the above, the problems and their solutions which are disclosed by this application will be clarified by the section of DESCRIPTION OF EMBODIMENTS and descriptions of drawings.

### ADVANTAGEOUS EFFECTS OF THE INVENTION

According to the present invention, the optimum trial production condition for the material can be proposed with excellent accuracy even when the number of pieces of the learning data used to construct the machine learning model(s) is small or when there is a bias in distribution of the learning data.

### BRIEF DESCRIPTION OF DRAWINGS

FIG. 1 is a schematic diagram illustrating the outline of a trial production condition proposal system according to one embodiment of the present invention;

FIG. 2 is a diagram illustrating functional blocks of the trial production condition proposal system according to one embodiment of the present invention;

FIG. 3 is a flowchart illustrating a flow of the entire processing of the trial production condition proposal system according to one embodiment of the present invention;

FIG. 4 is a flowchart illustrating the details of measured characteristics data preprocessing;

FIG. 5 is a flowchart illustrating the details of regression model construction processing;

FIG. 6 is a diagram illustrating a comparison of estimate accuracy before and after weighting; and

FIG. 7 is a flowchart illustrating the details of trial production condition proposal processing.

### DESCRIPTION OF EMBODIMENTS

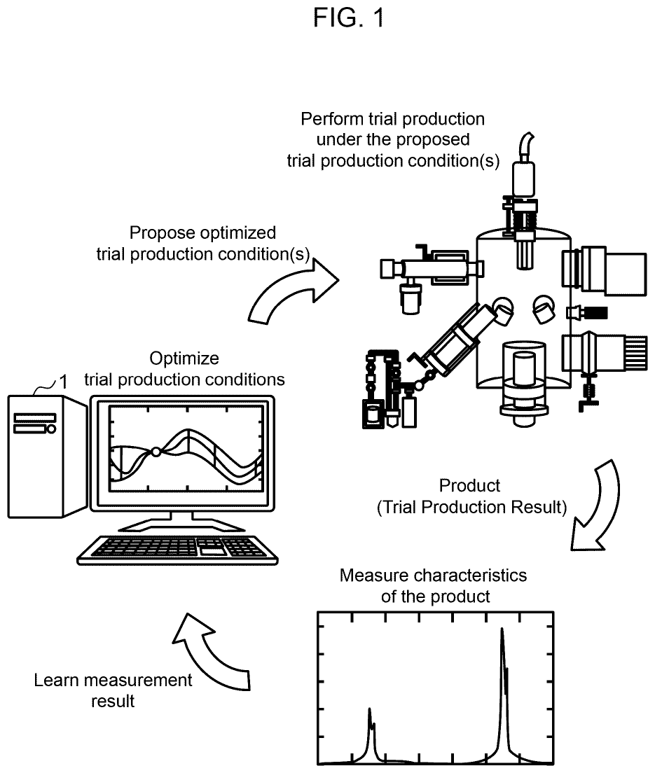

This embodiment will be described below in detail. FIG. 1 is a schematic diagram illustrating the outline of a trial production condition proposal system according to one embodiment of the present invention. A trial production condition proposal system 1 illustrated in FIG. 1 is designed to optimize each of various trial production conditions to be considered when performing trial production of a material, such as compositions of the material and firing conditions and to propose the results to a material developer who is a user of this system. This optimization of the trial production conditions is conducted by using various kinds of machine learning algorithms on the basis of measured characteristics data indicating the actual measurement results of characteristics of the relevant material. Moreover, when doing so, various kinds of regression models such as Gaussian process regression (GPR) and linear regression, regression trees (including a case by an ensemble method), regression by a neural network (Neural Network Regression), support vector regression (SVR), logistic regression, LASSO regression (Least Absolute Shrinkage and Selection Operator Regression) are used as prediction models.

As illustrated in FIG. 1, when the user of the trial production condition proposal system 1 performs trial production of a material under a trial production condition(s) proposed by the trial production condition proposal system 1 and evaluates characteristics of the material, which is a product of the trial production, measured characteristics data which indicates an evaluation value of the characteristics of this product is newly generated. After the trial production condition proposal system 1 is caused to learn this measured characteristics data as new learning data, the trial production condition proposal system 1 proposes a more optimized trial production condition(s) to the user. Every time the user repeats this cycle, the trial production condition proposal system 1 according to this embodiment can propose the trial production condition(s) with a better predicted value of the characteristics. Incidentally, the trial production condition proposal system may include a function to perform trial production of the material and a function to actually measure the characteristics of the material which is the object of the trial production, and may be configured integrally with these functions.

The trial production condition proposal system 1 according to this embodiment is realized by one general-purpose computer device as illustrated in FIG. 1. The following explanation will be given by assuming that the trial production condition proposal system 1 is realized by one general-purpose computer device including one or more processor devices, one or more storage devices, one or more input/output devices, and wired or wireless communication lines connecting these components (either of which is not illustrated in the drawing).

This computer device is installed as, for example, a terminal inside a laboratory and is connected to various kinds of other terminals which are installed inside and outside the laboratory, various kinds of terminals such as laptop PCs, tablets, and smartphones owned by each user (hereinafter referred to as the “user's terminals”), and other equipment such as a server device(s) via a communication network such as the Internet 400 and dedicated lines. Incidentally, the computer device and the Internet 400 are connected by wire via well-known communication equipment (which is not illustrated in the drawing), but they may be connected wirelessly.

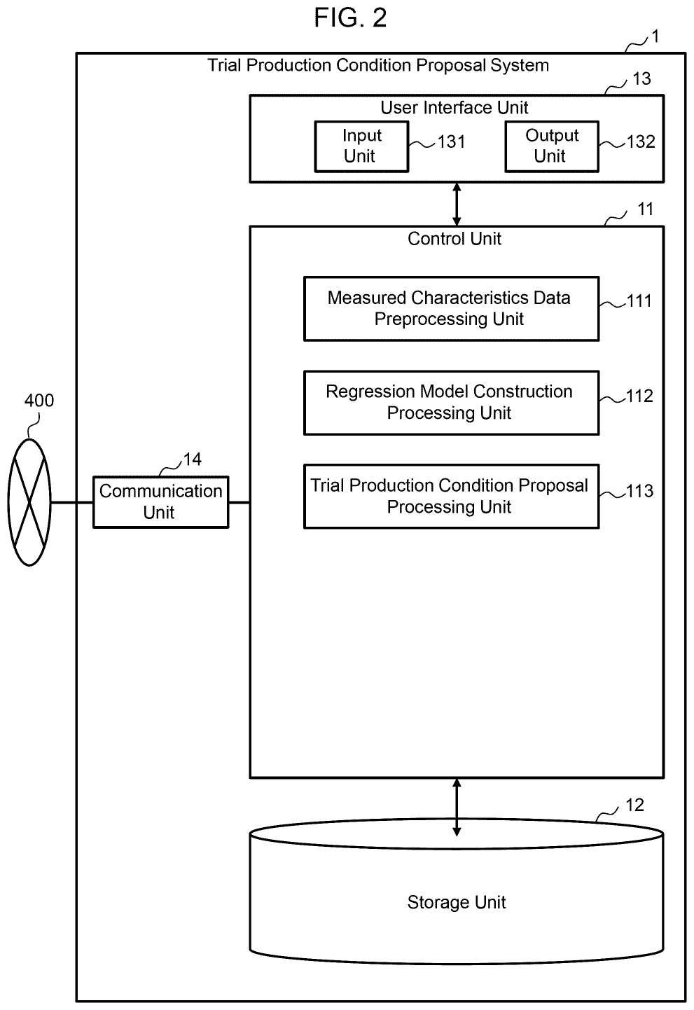

Next, an explanation will be provided about various kinds of functions included by the trial production condition proposal system 1 by referring to FIG. 2. FIG. 2 is a diagram illustrating functional blocks of the trial production condition proposal system according to one embodiment of the present invention. Incidentally, the respective blocks explained below indicate functional unit blocks, but not hardware unit components. The trial production condition proposal system 1 according to this embodiment is configured by including, as illustrated in FIG. 2, a control unit 11, a storage unit 12, a user interface unit 13, and a communication unit 14.

The control unit 11 executes various kinds of data processing based on the user's operation inputs detected by the user interface unit 13, data acquired by the communication unit 14, and programs and data which are stored in the storage unit 12. The control unit 11 also functions as an interface for the user interface unit 13, the communication unit 14, and the storage unit 12.

The control unit 11 has respective functional blocks of a measured characteristics data preprocessing unit 111, a regression model construction processing unit 112, and a trial production condition proposal processing unit 113. The control unit 11 is configured by using, for example, processor devices such as a CPU (Central Processing Unit) and various kinds of co-processors (hereinafter also simply referred as “processors”) and can implement blocks these functional by executing specified programs. Incidentally, the control unit 11 may be configured by using, for example, logical circuits such as an FPGA (Field Programmable Gate Array), instead of the processors. Moreover, the control unit 11 may be configured by a combination of the processors and the logical circuits.

The programs to be executed by the control unit 11 may be installed from a program source(s). The program source(s) may be, for example, a recording medium/media or the like which can be read by a program distribution computer(s) or a computer(s). Moreover, the programs executed by the control unit 11 may be configured by a device driver, an operating system, various kinds of application programs positioned in an upper layer thereof, and a library which provides common functions to these programs. Moreover, two or more programs may be implemented as one program and one program may be implemented as two or more programs.

The measured characteristics data preprocessing unit 111 applies preprocessing to the measured characteristics data in a state of so-called raw data immediately after it is recorded. This processing performed by the measured characteristics data preprocessing unit 111 will be referred to as measured characteristics data preprocessing.

The regression model construction processing unit 112 executes processing for constructing a regression model(s) regarding the measured characteristics data to which the preprocessing has been applied. This processing executed by the regression model construction processing unit 112 will be referred to as regression model construction processing.

The trial production condition proposal processing unit 113 executes processing for searching the measured characteristics data, to which the preprocessing has been applied, for an optimum trial production condition(s) for the material by using the regression model constructed by the regression model construction processing unit 112, and proposing the trial production condition(s) for the material to the user based on the search result. This processing executed by the trial production condition proposal processing unit 113 will be referred to as trial production condition proposal processing.

Incidentally, the specific content of these processing sequences will be described later.

The storage unit 12 is configured by using, for example, storage devices such as a RAM(s) and a flash memory/memories and stores programs for supplying various kinds of processing instructions to the control unit 11 and data indicating various kinds of information to be used for the processing executed by the control unit 11. For example, the measured characteristics data to which the preprocessing has been applied by the measured characteristics data preprocessing unit 111 (hereinafter referred to as “preprocessed data”), data indicating regression models created by the regression model construction processing unit 112, and so on are stored in the storage unit 12. The control unit 11 can implement the respective functional blocks of the measured characteristics data preprocessing unit 111, the regression model construction processing unit 112, and the trial production condition proposal processing unit 113 mentioned earlier by reading/writing these pieces of information from/to the storage unit 12.

The user interface unit 13 is in charge of, besides accepting input operations from the user, processing relating to the user interface such as image display and sound output. The user interface unit 13 has respective functional blocks of an input unit 131 and an output unit 132. The input unit 131 detects various kinds of operations from the user. The input unit 131 is configured by using, for example, a keyboard, a pointing device, a touch panel, and so on. The output unit 132 executes, for example, screen display and sound output for the user. The output unit 132 is configured by using, for example, a liquid crystal display and a touch screen.

The communication unit 14 is in charge of communication processing, which is performed via the Internet 400, with other equipment such as the user's terminal(s) possessed by each user, the server device(s), and so on. The communication unit 14 is configured by using, for example, an NIC (Network Interface Card) and an HBA (Host Bus Adapter).

This embodiment has been explained by describing that the respective functions of the trial production condition proposal system 1 are integrally implemented by one computer device. However, these respective functions may be implemented by a plurality of mutually connected computer devices or server devices. Also, the trial production condition proposal system 1 may be configured by including a general-purpose computer device such as a laptop PC, and a web browser which is installed in this general-purpose computer device or may be configured by including a web server and various kinds of portable equipment.

Moreover, the explanation about each function is an example and a plurality of functions may be put together as one function or one function may be divided into a plurality of functions.

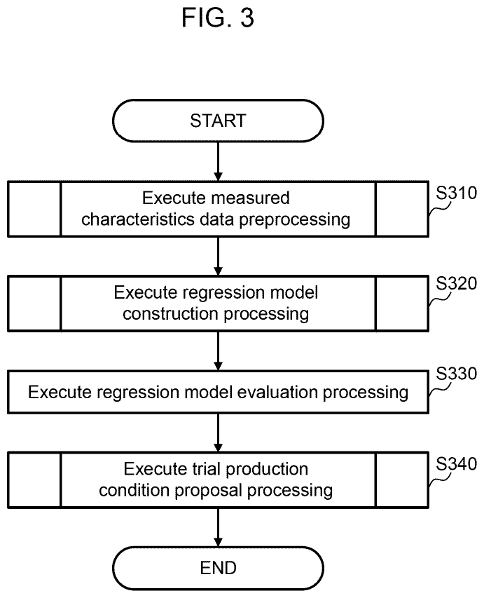

Next, an explanation will be provided about a flow of the entire processing of the trial production condition proposal system 1 with reference to FIG. 3. FIG. 3 is a flowchart illustrating a flow of the entire processing of the trial production condition proposal system according to one embodiment of the present invention. Incidentally, in the following explanation, there is a case where processing will be explained by referring to each function or program mentioned earlier as a subject; however, the processing explained by referring to the function or the program as the subject may be processing performed by a processor or a device having that processor.

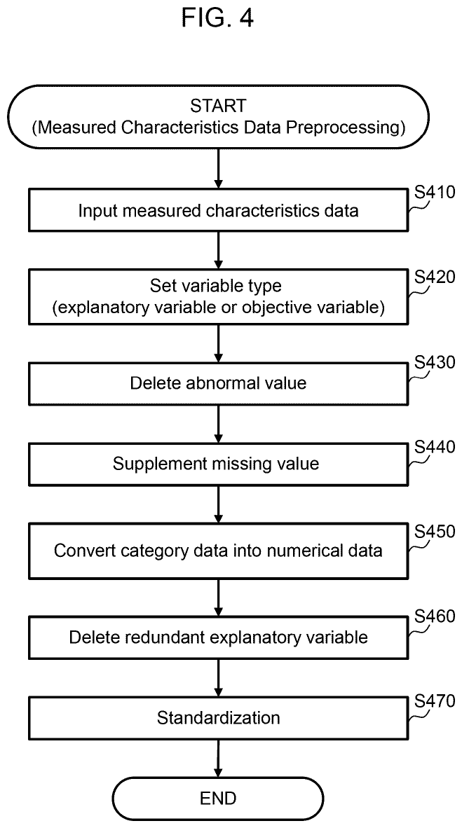

In step S310, the control unit 11 causes the measured characteristics data preprocessing unit 111 to execute the measured characteristics data preprocessing. Accordingly, the preprocessing is applied to the measured characteristics data, which then becomes the preprocessed data, so that it becomes possible to normally execute each subsequent processing. Incidentally, the details of the measured characteristics data preprocessing performed in step S310 will be explained later with reference to a flowchart in FIG. 4. When the measured characteristics data preprocessing is completed, the control unit 11 proceeds to step S320.

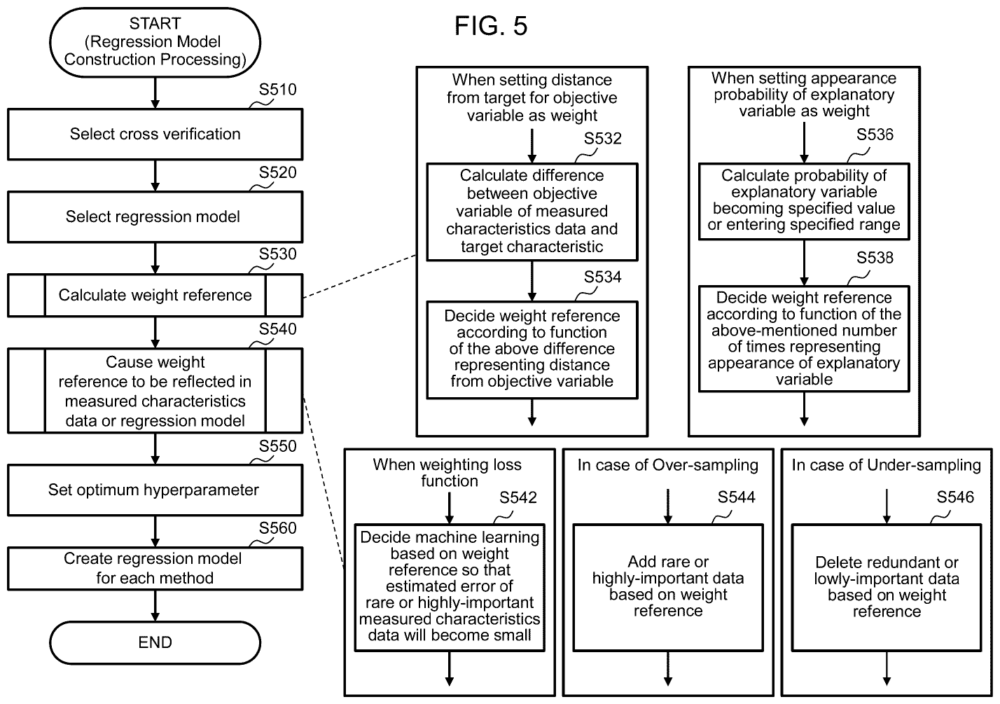

In step S320, the control unit 11 causes the regression model construction processing unit 112 to execute the regression model construction processing. Accordingly, a regression model is constructed regarding the preprocessed data. Incidentally, the details of the regression model construction processing performed in step S320 will be explained later with reference to a flowchart in FIG. 5. When the regression model construction processing is completed, the control unit 11 proceeds to step S330.

In step S330, the control unit 11 executes the regression model evaluation processing. This regression model evaluation processing is to evaluate generalization performance which is an index indicating prediction accuracy of the relevant regression model with respect to each of the plurality of regression models constructed as a result of the respective processing sequences before and in step S320. This evaluation is conducted by performing, for example, cross validation with other regression models. The evaluation result is visualized by, for example, a graph such as a scatter diagram or a box-and-whisker diagram. As a result, the user can receive a proposal of the trial production condition(s) based on the regression model with good generalization performance. When the regression model evaluation processing is completed, the control unit 11 proceeds to step S340.

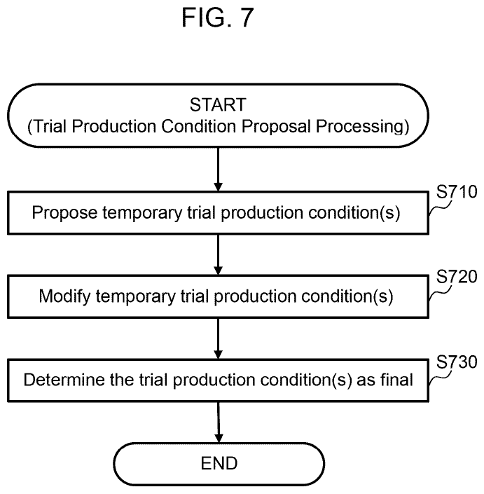

In step S340, the control unit 11 causes the trial production condition proposal processing unit 113 to execute the trial production condition proposal processing. With this trial production condition proposal processing, the user of the trial production condition proposal system 1 can modify the trial production condition(s) for the material, which has been proposed by the trial production condition proposal system 1, as appropriate to make them further preferable. The control unit 11 finds a predicted value of characteristics of the material if the material is to be trial produced under the trial production condition(s) modified by the user, by applying it to the selected regression model and presents the predicted value to the user. Specifically speaking, the user can interactively perform this work to modify the trial production condition(s) while checking the predicted value. Accordingly, the trial production condition proposal system 1 is designed as a system capable of incorporating the knowledge of the user, who is a developer of the relevant material, into the trial production condition(s) for the material to be proposed to the user. Incidentally, the details of the trial production condition proposal processing performed in step S340 will be explained later with reference to a flowchart in FIG. 7. When the trial production condition proposal processing is completed, the control unit 11 terminates the processing illustrated in the flowchart in FIG. 3 once.

The trial production condition proposal system 1 according to this embodiment executes each processing in steps S310 to S340 in FIG. 3 and proposes a good trial production condition(s) to the user. Specifically speaking, with the trial production condition proposal system 1 according to this embodiment, in step S310, the necessary preprocessing is automatically applied to the measured characteristics data in a state of raw data. So, each processing in steps S320 to S340 can be executed without manually performing the complicated preprocessing on the measured characteristics data. Moreover, with the trial production condition proposal system 1 according to this embodiment, the user can select a regression model with good generalization performance. Therefore, the trial production condition proposal system 1 can propose the trial production condition(s), regarding which the predicted characteristic value is good, to the user.

Incidentally, as described earlier in relation to FIG. 1, after the user of the trial production condition proposal system 1 performs the trial production of the material under the trial production conditions proposed by the trial production condition proposal system 1, actually measures the characteristics of the product, and causes the trial production condition proposal system 1 to learn data indicating the actual measurement result as new measured characteristics data, the user can then cause the trial production condition proposal system 1 to execute each processing in steps S310 to S340 in FIG. 3 again. In this case, the trial production condition proposal system 1 can propose a more optimized trial production condition(s) to the user. Specifically speaking, every time the trial production condition proposal system 1 according to this embodiment repeats each processing in steps S310 to S340 in FIG. 3 with respect to the same trial production object, it can propose the trial production condition(s) with a better predicted value of the characteristics.

FIG. 4 is a flowchart illustrating the details of the measured characteristics data preprocessing.

In step S410, the control unit 11 causes the measured characteristics data preprocessing unit 111 to receive an input of the measured characteristics data from the user via the input unit 131 or the communication unit 14. The measured characteristics data to be input to the trial production condition proposal system 1 may be, for example, category data, continuous data, or discrete data. Moreover, a specific data format of the measured characteristics data to be input to the trial production condition proposal system 1 can be decided as appropriate. When the processing in step S410 is completed, the control unit 11 proceeds to step S420.

In step S420, the control unit 11 causes the measured characteristics data preprocessing unit 111 to set a variable type with respect to the measured characteristics data whose input is received from the user in step S410. Under this circumstance, either an explanatory variable(s) or an objective variable(s) is set. The explanatory variable(s) is a variable which serves as the basis for finding a predicted value of the characteristics. In this embodiment, the composition of the material, firing conditions, etc. which constitute the trial production conditions correspond to the explanatory variables. Moreover, the objective variable(s) is a variable(s) which indicates a characteristic value(s) of the material to be trial produced, which becomes a prediction object. As an example of specific processing in step S420, the explanatory variable may be set as a default and a setting operation may be accepted from the user who wants to change it to the objective variable. When the processing in step S420 is completed, the control unit 11 proceeds to step S430.

In step S430, the control unit 11 causes the measured characteristics data preprocessing unit 111 to judge whether or not there is any abnormal value with respect to the measured characteristics data to which either one of the explanatory variable and the objective variable is set in step S420. This processing for judging whether any abnormal value exists or not is performed by, for example, indicating the measured characteristics data as a histogram and judging whether or not there is any outlier outside the range of an average value ±2σ, and then judging whether there is any data input error or any failure of an evaluation test device upon generation of the measured characteristics data regarding which it is determined that the outlier exists. On one hand, when it is determined that the measured characteristics data includes an abnormal value, the control unit 11 deletes that abnormal value and recognizes it as a missing value and proceeds to step S440. Moreover, if the type of the abnormal value included in the measured characteristics data is one of the variables, that is, an objective variable where explanatory variables are completely duplicated and there is a standard with different characteristics, the control unit 11 deletes a sample(s) relating to this abnormal value and proceeds to step S440. In such a case where all the explanatory variables are duplicated and the standard with different characteristics is treated as an abnormal value, it is necessary to delete the standard itself unlike the case where one part of the explanatory variable is an abnormal value due to, for example, an input error. On the other hand, if it is determined that no abnormal value is included in the measured characteristics data, the control unit 11 directly proceeds to step S440.

Incidentally, when all the explanatory variables are duplicated and there is the standard with different characteristics as described above, the duplication may be considered to be meaningful and all the explanatory variables may be sometimes desired to be remained. In such a case, the trial production condition proposal system 1 according to this embodiment can omit the processing in step S430.

In step S440, the control unit 11 causes the measured characteristics data preprocessing unit 111 to judge whether or not there is a missing value(s) regarding the measured characteristics data. This judgment is because performed the measured characteristics data sometimes includes the missing value in advance. On one hand, if it is judged that the missing value(s) is included in the measured characteristics data, the control unit 11 supplements the missing value(s) and proceeds to step S450. The missing value supplementation processing is performed by, for example, using an average value, a median value, a minimum value, a maximum value, and so on of the measured characteristics data, excluding an abnormal value(s), as values to supplement the missing value(s). Moreover, the missing value(s) may be supplemented by means of linear interpolation. Incidentally, when the missing value(s) is supplemented in step S440, the measured characteristics data preprocessing unit 111 may, for example, display the supplemented value in red letters in order to make it easier to identify the supplemented value. Moreover, the measured characteristics data preprocessing unit 111 may, for example, delete standards themselves without supplementing the relevant missing value in step S440. Furthermore, with the trial production condition proposal system 1 according to this embodiment, if a missing ratio of the explanatory variables is large, for example, if 50% or more of the data quantity is missing, the measured characteristics data preprocessing unit 111 can delete the relevant explanatory variables themselves. On the other hand, if it is judged that the missing value(s) is not included in the measured characteristics data, the control unit 11 directly proceeds to step S450.

In step S450, if the explanatory variable is not a continuous value, but a category value, the control unit 11 causes the measured characteristics data preprocessing unit 111 to perform encoding processing on the relevant explanatory variable and convert it to numerical value data. The measured characteristics data preprocessing unit 111 executes this encoding processing by, for example, referring to a record in a table which indicates the correspondence relationship between the category data and the numerical value data and is stored in the storage unit 12. When the processing in step S450 is completed, the control unit 11 proceeds to step S460.

In step S460, the control unit 11 causes the measured characteristics data preprocessing unit 111 to judge whether or not any redundant explanatory variable(s) is included in the measured characteristics data. This judgment is performed on the basis of whether or not a combination of explanatory variables with a correlation coefficient equal to or more than a specified number, for example, 0.8 or more can be extracted. On one hand, if it is judged that any redundant explanatory variables are included in the relevant measured characteristics data, the control unit 11 deletes one of the redundant explanatory variables and proceeds to step S470. Incidentally, with the trial production condition proposal system 1 according to this embodiment, the combination of the explanatory variables whose correlation coefficient is equal to or more than 0.8 is visualized for the user via the output unit 132, so that the explanatory variable to be deleted can be selected via the input unit 131. On the other hand, if it is judged that any redundant explanatory variable(s) is not included in the relevant measured characteristics data, the control unit 11 directly proceeds to step S470.

In step S470, the control unit 11 the measured characteristics data preprocessing unit 111 to perform standardization processing on the measured characteristics data as necessary. This standardization processing is to transform the scale of the measured characteristics data so that an average=0 and a standard deviation (variance)=1 will be obtained. When the processing in step S470 is completed, the control unit 11 stores the preprocessed data, that is, the measured characteristics data to which the preprocessing has been applied in steps S410 to S470 in FIG. 4, in the storage unit 12 and terminates the measured characteristics data preprocessing illustrated in the flowchart in FIG. 4. Incidentally, the control unit 11 may cause the measured characteristics data preprocessing unit 111 to perform normalization processing on the measured characteristics data as necessary. In such a case, each of the subsequent processing may be executed without performing the standardization processing in S470.

FIG. 5 is a flowchart illustrating the details of the regression model construction processing.

In step S510, the control unit 11 causes the regression model construction processing unit 112 to select a condition(s) to implement cross validation in order to evaluate a regression model to be constructed regarding the preprocessed data. Incidentally, the trial production condition proposal system 1 according to this embodiment evaluates each regression model by means of K-fold Cross Validation. Moreover, as its implementation condition, K=10 is set as a default value. In this case, the trial production condition proposal system 1 evaluates the regression model by means of 10-fold cross validation. Incidentally, the trial production condition proposal system 1 according to this embodiment, the user can also select the cross-validation implementation condition(s). Specifically speaking, the regression model construction processing unit 112 can accept the cross-validation implementation condition(s) from the user via the input unit 131 or the communication unit 14. When the processing in step S510 is completed, the control unit 11 proceeds to step S520.

In step S520, the control unit 11 causes the regression model construction processing unit 112 to select a candidate(s) for the regression model to be used as a prediction model for the search of the trial production condition(s). When this happens, the regression model construction processing unit 112 selects, as the candidate(s), a regression model(s) regarding which it has accepted selection processing from the user via the input unit 131 or the communication unit 14. With the trial production condition proposal system 1 according to this embodiment, the user can select a plurality of regression models as the candidates from various kinds of regression models of, for example, Gaussian process regression, the aforementioned linear regression, regression trees (including a case by an ensemble method), regression via a neural network, support vector regression, logistic regression, and LASSO regression. When the processing in step S520 is completed, the control unit 11 proceeds to step S530.

In step S530, the control unit 11 causes the regression model construction processing unit 112 to execute processing for calculating a weight reference which is a reference for weighting on the measured characteristics data. The weight reference is calculated based on the difference between the objective variable included in the measured characteristics data and a target characteristic indicating a target value of the characteristics of the material or a statistic amount indicating rarity of the explanatory variable included in the measured characteristics data (the details will be described later). Incidentally, a specific example of the statistic amount indicating the rarity of the explanatory variable can include an appearance probability of the explanatory variable which satisfies a specified condition(s). When the processing in step S530 is completed, the control unit 11 proceeds to step S540.

In step S540, the control unit 11 causes the regression model construction processing unit 112 to execute processing for performing weighting on the measured characteristics data based on the weight reference calculated in step S530. Moreover, with the trial production condition proposal system 1 according to this embodiment, the regression model construction processing unit 112 can directly perform weighting on the regression model based on the weight reference calculated in step S530. Incidentally, the processing executed in step S540 by the regression model construction processing unit 112 based on the result of step S530 is specifically either one of processing for setting a loss function which is a function serving as a learning index, over-sampling processing for amplifying rare or highly-important measured characteristics data and adding the amplified data as learning data, and under-sampling processing for deleting redundant or lowly-important measured characteristics data from the learning data (the details will be described later). As these processing sequences are executed, the weight of the above-described learning data is adjusted as appropriate even when the number of pieces of learning data to be used to construct a machine learning model is small or when there is a bias in distribution of the learning data. As a result, it is possible to enhance the estimate accuracy and propose the trial production condition(s) for a good material with excellent accuracy. When the processing in step S540 is completed, the control unit 11 proceeds to step S550.

In step S550, the control unit 11 causes the regression model construction processing unit 112 to search for and set an optimum hyperparameter with respect to each regression model for each method, which is selected as a candidate in step S520. With the trial production condition proposal system 1 according to this embodiment, the regression model construction processing unit 112 automatically searches for all parameters for each regression model and automatically sets a parameter which will realize the best generalization performance of the relevant regression model when setting the parameter as a hyperparameter upon the construction of the regression model. When the processing in step S550 is completed, the control unit 11 proceeds to step S560.

In step S560, the control unit 11 causes the regression model construction processing unit 112 to perform processing for creating a regression model(s) for each method for which the optimum hyperparameter is set. When the regression model construction processing unit 112 creates the regression model for each method, it performs processing for selecting a regression model with the highest generalization performance from among all the created regression models and deciding a final regression model. When the processing in step S560 is completed, the control unit 11 terminates the regression model construction processing illustrated in the flowchart in FIG. 5.

Incidentally, the weight reference is calculated as described earlier based on the difference between the objective variable included in the measured characteristics data and the target characteristic indicating the target value of the characteristics of the material or the statistic amount indicating the rarity of the explanatory variable included in the measured characteristics data.

Of the above-described bases, on one hand, the specific content of the processing executed in step S530 when the weight reference is calculated based on the difference between the objective variable included in the measured characteristics data and the target characteristic indicating the target value of the characteristics of the material will be described below as steps S532 to S534.

In step S532, the control unit 11 causes the regression model construction processing unit 112 to calculate the difference between the objective variable included in the measured characteristics data and the target characteristic indicating the target value of the characteristics of the material. When the processing in step S532 is completed, the control unit 11 proceeds to step S534.

In step S534, the control unit 11 causes the regression model construction processing unit 112 to decide the weight reference by means of a function of the difference between the objective variable and the target characteristic as calculated in step S532. Specific examples of this function can be an absolute value or a square value of the difference between the objective variable and the target characteristic, which indicates the distance between the objective variable and the target characteristic. Incidentally, the reason why the weight reference is decided based on the distance between the objective variable and the target characteristic is that regression problems are often solved for the material development and, therefore, the number of times of appearance of the objective variable, which is generally used to decide the weight reference for classification problems, cannot be used. So, with the trial production condition proposal system 1 according to this embodiment, the weight reference based on the objective variable which is a continuous variable is used. When the processing in step S534 is completed, the control unit 11 terminates the processing for calculating the weight reference illustrated in step S530 and proceeds to step S540.

On the other hand, the specific content of the processing executed in step S530 when the weight reference is calculated based on the statistic amount indicating the rarity of the explanatory variable included in the measured characteristics data will be described below as steps S536 to S538.

In step S536, the control unit 11 causes the regression model construction processing unit 112 to calculate the number of times of appearance of the explanatory variable which becomes a specific value or enters specified range. Specifically, for example, when the explanatory variable relates to a raw material ratio of various kinds of raw materials, the explanatory variable which becomes a value larger than 0, in other words, the number of times of appearance of the explanatory variable which indicates the raw material ratio that is actually used is calculated. When the processing in step S536 is completed, the control unit 11 proceeds to step S538.

In step S538, the control unit 11 causes the regression model construction processing unit 112 to decide the weight reference by means of the function of the number of times of appearance of the explanatory variable as calculated in step S536. A specific example of this function can be an appearance probability of the explanatory variable in the entire learning data. Moreover, the regression model construction processing unit 112 may decide the number of times of appearance of the explanatory variable as the weight reference instead of deciding the appearance probability of the explanatory variable as the weight reference. Incidentally, the reason why the reference based on the explanatory variable is used is because the knowledge of the user, who is the material developer, about the materials science is to be incorporated particularly regarding an important parameter(s) which is not indicated by the objective variable. When the processing in step S538 is completed, the control unit 11 terminates the processing for calculating the weight reference indicated in step S530 and proceeds to step S540.

Moreover, in step S540, the regression model construction processing unit 112 performs on weighting the measured characteristics data or the regression model as described earlier by executing either one of the processing for setting the loss function, the over-sampling processing for amplifying the rare or highly-important measured characteristics data and adding the amplified data as the learning data, and the under-sampling processing for deleting the redundant or lowly-important measured characteristics data from the learning data. Specifically speaking, the regression model construction processing further includes either one of the following processing executed based on the calculated weight reference, that is, the processing for setting the loss function, the over-sampling processing for amplifying the rare or highly-important measured characteristics data and adding the amplified data as the learning data, and the under-sampling processing for deleting the redundant or lowly-important measured characteristics data from the learning data.

Of the above-described processing, the specific content of the processing executed in step S530 when setting the loss function based on the weight reference calculated in step S530 will be explained below as step S542.

In step S542, the control unit 11 causes the regression model construction processing unit 112 to decide machine learning so that a prediction error of the rare or highly-important measured characteristics data will become small based on the weight reference calculated in step S530. This processing is performed by applying weighting on the measured characteristics data via the loss function upon learning. When the processing in step S538 is completed, the control unit 11 terminates the processing for causing the weight reference indicated in step S540 to be reflected in the learning data or the regression model and proceeds to step S550.

Moreover, the specific content of the processing called the over-sampling processing or up-sampling processing which is executed in step S530 when amplifying the rare or highly-important measured characteristics data and adding the amplified data as the learning data on the basis of the weight reference calculated in step S530 will be explained below as step S544.

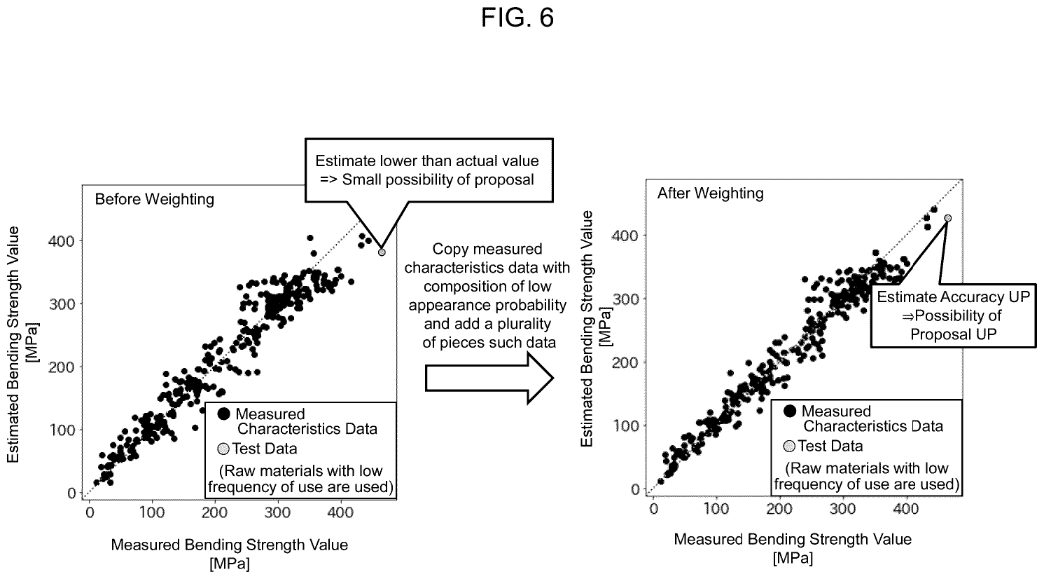

In step S544, the control unit 11 causes the regression model construction processing unit 112 to duplicate the rare or highly-important measured characteristics data, which is the object of the over-sampling, based on the weight reference calculated in step S530 and add the duplicated data to the learning data. In this case, the measured characteristics data is duplicated until its quantity becomes equal to or more than a specified threshold value. Moreover, the over-sampling processing may be executed by various kinds of methods such as SMOTE, ADASYN, Borderline-SMOTE, and Safe-level SMOTE other than the method of adding the duplicate measured characteristics data to the learning data. Accordingly, the rare or highly-important measured characteristics data is added to the learning data, thereby improving the balance of the learning data. The comparison of the estimate accuracy before and after the weighting processing via the over-sampling which is executed in step S544 is illustrated in FIG. 6. FIG. 6 shows the measured characteristics data regarding bending strength, which is one of characteristics relating to a ceramic composite material produced from a plurality of certain raw materials, and their predicted values in a scatter diagram. FIG. 6 shows that, as a result of performing weighting on the measured characteristics data relating to the certain specific raw materials via the over-sampling processing executed in step S544, regarding which the estimate accuracy has not achieved sufficiently because the number of times the raw materials are used in the entire measured data is small, errors between the estimate values and the measured values regarding this composite material have been successfully reduced, in other words, the estimate accuracy regarding this composite material has been successfully enhanced. When the processing in step S544 is completed, the control unit 11 terminates the processing for causing the weight reference to be reflected in the learning data or the regression model as indicated in step S540 and proceeds to step S550.

Moreover, the specific content of the processing called the under-sampling processing or down-sampling processing which is executed in step S540 when deleting the redundant or lowly-important measured characteristics data from the learning data on the basis of the weight reference calculated in step S530 will be explained below as step S546.

In step S546, the control unit 11 causes the regression model construction processing unit 112 to delete the redundant or lowly-important measured characteristics data from the learning data. Accordingly, the redundant or lowly-important measured characteristics data is deleted from the learning data, thereby improving the balance of the learning data. When the processing in step S546 is completed, the control unit 11 terminates the processing for causing the weight reference to be reflected in the learning data or the regression model as indicated in step S540 and proceeds to step S550.

FIG. 7 is a flowchart illustrating the details of the trial production condition proposal processing.

In step S710, the control unit 11 causes the trial production condition proposal processing unit 113 to perform processing for searching for the trial production conditions based on the regression model created in step S560 in FIG. 5. The trial production condition proposal processing unit 113 executes this processing by means of optimization processing. Incidentally, the trial production condition proposal system 1 according to this embodiment is configured to be capable of using various kinds of optimization processing methods such as Mathematical Optimization (MO), Bayesian optimization (BO), Genetic Algorithm (GA), the Newton's Method (NM), and the Simplex Method (SM). As a result, the respective explanatory variables when a predicted value of the characteristics, that is, the objective variable becomes the best are proposed to the user as the temporary trial production conditions indicating the results of the relevant search processing. Moreover, under this circumstance, the trial production condition proposal processing unit 113 performs sensitivity analysis of the relevant temporary trial production conditions, evaluates the importance of the respective explanatory variables which constitute the relevant temporary trial production conditions, and the evaluation presents results together. Incidentally, if the used regression model is the Gaussian process regression, the trial production condition proposal system 1 according to this embodiment can select the trial production conditions which will maximize the acquisition function. When the processing in step S710 is completed, the control unit 11 proceeds to step S720.

In step S720, the control unit 11 causes the trial production condition proposal processing unit 113 to accept a modification(s) of the temporary trial production conditions, which have been proposed to the user in step S710, from the user. After accepting an input operation relating to the modification(s) of the values of the respective explanatory variables which constitute the temporary trial production conditions via the input unit 131 or the communication unit 14, the trial production condition proposal processing unit 113 modifies the temporary trial production conditions according to the modification content. Incidentally, under this circumstance, the control unit 11 causes to: find a predicted value of the characteristics of the material when the material is trial produced under the modified temporary trial production conditions by using the regression model; and present the calculation result to the user. Moreover, under this circumstance, the trial production condition proposal processing unit 113 also performs the sensitivity analysis of the modified temporary trial production conditions in the same manner as in step S710, evaluates the importance of the explanatory variables which constitute the relevant modified temporary trial production conditions, and presents the evaluation results together. Incidentally, these evaluation results are updated every time the user modifies the temporary trial production conditions; and the latest evaluation results are always presented to the user. When the processing in step S720 is completed, the control unit 11 proceeds to step S730.

In step S730, the control unit 11 causes the trial production condition proposal processing unit 113 to judge whether or not the predicted value of the characteristics as found in step S720 regarding the modified temporary trial production conditions is insufficient as a characteristic value of the material which is an object of the trial production. For example, if the regression model to be used is the Gaussian process regression, this judgment is performed with respect to each trial production condition by finding an acquisition function, which indicates an expected value of an improvement of the characteristics of the material which is trial produced under the relevant trial production condition, with respect to the modified temporary trial production condition and judging whether or not the difference between the value of the relevant acquisition function and a maximum value of the acquisition function is within a specified range. Incidentally, the acquisition function is calculated based on the predicted value μ of the characteristics of the material and a standard deviation σ indicating variations of the relevant predicted value when the trial production of the material is performed under an arbitrary trial production condition. If it is judged that the predicted characteristic value is insufficient, the processing returns to step S720 and accepts an instruction to modify the trial production conditions from the user again; and if it is judged that the predicted characteristic value is not insufficient, this means that the predicted value of the characteristics of the material when performing the trial production under the relevant modified temporary trial production condition is sufficient, so that the temporary trial production condition(s) is determined as final and a proposal is made to the user that the trial production condition has been finalized. Specifically speaking, this judgment processing is performed repeatedly until it is judged that the predicted value of the characteristics of the material relating to the temporary trial production condition(s) is not insufficient. When the processing in step S730 is completed, the control unit 11 terminates the trial production condition proposal processing illustrated in the flowchart in FIG. 7.

Incidentally, when the user performs the trial production of the material under the trial production condition(s) proposed in step S730 in FIG. 7 and the data indicating the actual measurement result of the characteristics of the product is input as new measured characteristics data, the trial production condition proposal system 1 according to this embodiment proposes more optimized trial production condition(s) to the user on the basis of the newly input measured characteristics data as described above. In this case, the control unit 11 for the trial production condition proposal system 1 judges whether or not any missing value is included in the newly input measured characteristics data. On one hand, if it is judged that a missing value is included, the measured characteristics data preprocessing is applied to the newly input measured characteristics data in order to supplement this missing value by starting the processing from step S440 in FIG. 4. On the other hand, if it is judged that any missing value is not included, it is unnecessary to perform the measured characteristics data preprocessing on the newly input measured characteristics data. Therefore, in such a case, the control unit 11 judges whether or not it is necessary to update the regression model. On one hand, if it is judged that it is necessary to update the regression model, the control unit 11 executes the regression model construction processing on the newly input measured characteristics data by starting the processing from step S510 in FIG. 5 in order to create a regression model again. On the other hand, if it is judged that it is unnecessary to update the regression model, the control unit 11 omits the regression model construction processing and the regression model evaluation processing and performs the trial production condition proposal processing on the newly input measured characteristics data by starting the processing from step S710 in FIG. 7 by using the regression model created last time. Incidentally, if it is unnecessary to update the regression model even when a missing value is included in the newly input measured characteristics data, the control unit 11 similarly omits the regression model construction processing and the regression model evaluation processing.

According to the above-described embodiment of the present invention, the following operational advantages can be achieved.

(1) The trial production condition proposal system 1 is a system for proposing a trial production condition(s) for a material(s) to a material developer and includes the regression model construction processing unit 112 and the trial production condition proposal processing unit 113. The regression model construction processing unit 112 executes the regression model construction processing on the measured characteristics data indicating the actual measurement result of the characteristics of the material (step S320). The trial production condition proposal processing unit 113 searches for an optimum trial production condition for the material by using the constructed regression model and executes the trial production condition proposal processing by using the search result (step S340). The regression model construction processing (FIG. 5) includes: processing for calculating the weight reference which is a reference for weighting on the measured characteristics data (step S530); and processing for performing weighting on the measured characteristics data based on the calculated weight reference (step S540). Accordingly, even when the number of pieces of learning data used to construct a machine learning model is small or when there is a bias in distribution of the learning data, the weight of the above-described learning data is adjusted appropriately. As a result, it is possible to enhance the estimate accuracy and propose the trial production condition for a good material with excellent accuracy.

(2) The weight reference is calculated based on the difference between the objective variable included the in measured characteristics data and the target characteristic indicating a target value of the characteristics of the material (steps S532 to S534). Accordingly, the weight reference can be decided based on the objective variable even for the material development for which the weight reference cannot be decided based on the number of times of appearance of the objective variable because regression problems are often solved.

(3) The weight reference is calculated based on the statistic amount which indicates the rarity of the explanatory variable included in the measured characteristics data (steps S536 to S538). Accordingly, the weight reference can be calculated based on the explanatory variable. As a result, particularly regarding the important parameter(s) which is not indicated by the objective variable, it is possible to incorporate the knowledge of the user, who is the material developer, about the materials science.

(4) The regression model construction processing (FIG. 5) further includes processing for setting the loss function based on the calculated weight reference (step S542). Accordingly, it is possible to reduce any prediction error regarding rare or highly-important measured characteristics data.

(5) The regression model construction processing (FIG. 5) further includes the over-sampling processing (step S544) for amplifying the rare or highly-important measured characteristics data based on the calculated weight reference and adding the amplified data as learning data. Accordingly, the rare or highly-important measured characteristics data is added to the learning data. As a result, the sensitivity of the rare or highly-important measured characteristics data can be enhanced, thereby improving the balance of the learning data.

(6) The regression model construction processing (FIG. 5) further includes the under-sampling processing (step S546) for deleting redundant or lowly-important measured characteristics data from the learning data based on the calculated weight reference. Accordingly, the redundant or lowly-important measured characteristics data is deleted from the learning data. As a result, the sensitivity of the redundant or lowly-important measured characteristics data can be reduced, thereby improving the balance of the learning data.

Incidentally, the present invention is not limited to the above-described embodiment and can be implemented by using arbitrary constituent elements within the scope not departing from the gist of the invention.

The above-described embodiment and variations are merely examples and the present invention is not limited to their content unless the features of the invention are impaired. Moreover, various embodiments and variations are explained above, but the present invention is not limited to their content. Other aspects which can be thought of within the scope of technical ideas of the present invention are also included within the scope of the present invention.

### REFERENCE SIGNS LIST

1: trial production condition proposal system
11: control unit
12: storage unit
13: user interface unit
14: communication unit
111: measured characteristics data preprocessing unit
112: regression model construction processing unit
113: trial production condition proposal processing unit
131: input unit
132: output unit
400: Internet

1. A trial production condition proposal system for proposing a trial production condition for a material to a material developer,
the trial production condition proposal system comprising:
a regression model construction processing unit that executes regression model construction processing on measured characteristics data indicating an actual measurement result of characteristics of the material; and
a trial production condition proposal processing unit that searches for an optimum trial production condition for the material by using the constructed regression model and executes trial production condition proposal processing based on a search result,
wherein the regression model construction processing includes:
processing for calculating a weight reference which is a reference for weighting on the measured characteristics data; and
processing for performing weighting on the measured characteristics data based on the calculated weight reference.

2. The trial production condition proposal system according to claim 1,
wherein the weight reference is calculated based on a difference between an objective variable included in the measured characteristics data and a target characteristic indicating a target value of characteristics of the material.

3. The trial production condition proposal system according to claim 1,
wherein the weight reference is calculated based on a statistic amount indicating rarity of an explanatory variable included in the measured characteristics data.

4. The trial production condition proposal system according to claim 1,
wherein the regression model construction processing further includes processing for setting a loss function based on the calculated weight reference.

5. The trial production condition proposal system according to claim 1,
wherein the regression model construction processing further includes over-sampling processing for amplifying rare or highly-important measured characteristics data based on the calculated weight reference and adding the amplified measured characteristics data as learning data.

6. The trial production condition proposal system according to claim 1,
wherein the regression model construction processing further includes under-sampling processing for deleting redundant or lowly-important measured characteristics data from learning data based on the calculated weight reference.

7. A trial production condition proposal method for proposing a trial production condition for a material to a material developer by using a computer,
wherein the computer is caused to execute:
regression model construction processing for constructing a regression model regarding measured characteristics data indicating an actual measurement result of characteristics of the material; and
trial production condition proposal processing for searching for an optimum trial production condition for the material by using the constructed regression model, and proposing the trial production condition for the material based on a search result,
wherein the regression model construction processing includes:
processing for calculating a weight reference which is a reference for weighting on the measured characteristics data; and
processing for performing weighting on the measured characteristics data based on the calculated weight reference.
